(19) United States
(12) Patent Application Publication
(10) Pub. No.: US 2020/0010042 A1
(43) Pub. Date: Jan. 9, 2020

(54) AIRBAG DEVICE FOR INTERIOR TRIM ELEMENT OF A MOTOR VEHICLE

(71) Applicant: PSA Automobiles SA, Poissy (FR)

(72) Inventor: Pascal MARTIN, Bart (FR)

(21) Appl. No.: 16/493,679

(22) PCT Filed: Feb. 13, 2018
(86) PCT No.: PCT/FR2018/050349

§ 371 Date: Sep. 12, 2019

(30) Foreign Application Priority Data
Mar. 22, 2017 (FR) 1752344

(51) Int. Cl. B60R 21/205; B60R 21/217

(52) U.S. Cl. CPC B60R 21/205; B60R 21/217

(57) ABSTRACT

The present invention concerns an airbag device comprising a security module (10) comprising a rigid body forming a casing (12) and a firing channel (20) comprising a top wall (21), two transverse guide flanges (22, 23) and two transverse walls (32B), said body comprising two transverse flanks having teeth (16) engaged in windows (30) provided on said transverse flanges (22, 23) and two side walls (17) in each of which an opening (17B) is provided, positioned close to the vertical of one of said transverse walls (32B) so as to allow two rods (T) that have been inserted through these openings (17B) to bear on these transverse walls (32B) so as to pivot in order to exert a lever effect causing said module (10) to move in translation and the teeth (16) situated on one of said transverse flanks to disengage from the corresponding windows (30).

### CROSS-REFERENCE TO RELATED APPLICATIONS

This application is the US National Stage under 35 USC § 371 of International Application No. PCT/FR2018/050349, filed 13 Feb. 2018 which claims priority to French Application No. 1752344 filed 22 Mar. 2017, both of which are incorporated herein by reference.

### FIELD OF THE INVENTION

In general terms, the invention concerns an airbag device for an interior trim element of a motor vehicle. In particular, it concerns such an airbag device for the vehicle's dashboard, which deploys in the vehicle compartment in the event of an impact by passing through this dashboard in order to protect the occupant of the right front seat of the vehicle.

### BACKGROUND OF THE INVENTION

Motor vehicles are commonly provided with airbags designed to reduce the risk of injury to the occupant in the event of an accident.

These devices are conventionally fitted in areas where the driver or passengers are likely to come into contact with the internal elements of the vehicle. Consequently, an airbag device is usually mounted beneath the dashboard to protect the front passenger of the vehicle.

Such a device conventionally comprises a security module comprising a body forming a casing that houses the airbag and a gas generator to inflate the airbag, as well as a firing channel fixed to the dashboard to guide the deployment of the airbag when the gas generator is triggered in the event of an accident.

The body of an airbag module is usually rigid in order to control the geometry of the airbag in its folded configuration as well as the deformation on deployment of this airbag by withstanding the pressure generated.

The firing channel conventionally comprises a top wall, the peripheral edge of which is designed to rest fixedly against the perimeter of an opening provided in the body of the dashboard, as well as at least two transverse guide flanges provided to partially surround the security module.

It is known, particularly from US Pub. No. 2008/0023944, to fix the security module to the firing channel with the aid of hooks that are provided on two front and rear transverse sidewalls of its body and are designed to engage in corresponding orifices provided on the transverse guide flanges of the firing channel.

Alternatively, it is also known to provide, instead of hooks, snap-fit teeth that cooperate by clicking into windows provided in the transverse flanges of the firing channel.

After the security module has been triggered or as its expiry date approaches, it must be removed from the firing channel in order to be repaired or replaced under the after-sales service agreement.

Unfortunately, due to the fact that it is fitted between the dashboard and the passenger glove compartment, this security module is particularly difficult for an operator to access.

The removal of the hooks or snap-fit teeth is thus particularly tricky and also usually requires the use of special tools so that the transverse flanges can be distanced from the firing channel, and in the case of the transverse flanges being inaccessible, involves removing all or part of the vehicle's dashboard in order to access the security module.

In order to facilitate the removal of such a security module, it is known to provide a large assembly clearance between the transverse sidewalls of the firing channel and the transverse sidewalls of this security module.

However, such a solution has the drawback of considerably increasing the overall volume of the device and consequently the space required to install it.

Furthermore, it requires the use of sound damping means such as felt pads to prevent operating noise, which considerably increases the device's cost.

### SUMMARY

A simple and economic solution is disclosed to facilitate the removal of the security module of such an airbag device.

To this end, an airbag device for an interior trim element of a motor vehicle comprises a security module comprising a rigid body forming a casing that houses an airbag and a gas generator, as well as a firing channel comprising a top wall designed to be fixed against the interior trim element and two transverse guide flanges extending parallel to one another from and beneath the top wall partially surrounding the body. The body comprises two parallel transverse sidewalls each having a plurality of snap-fit teeth which engage with respective windows provided in the corresponding transverse flanges of the firing channel;

wherein the firing channel also comprises two transverse walls extending close to its two side ends from and beneath the top wall,

the body of the security module also comprising two extensions each having an orifice or hole positioned close to one of the respective transverse walls in order to enable rods to be inserted through these orifices up to the top wall of the firing channel to bear on these transverse walls such that they can pivot about a transverse axis in order to exert a lever effect causing the security module to move longitudinally relative to the firing channel and thereby disengaging the teeth situated on one of the transverse sidewalls from the corresponding windows of the transverse flange of the firing channel.

The particular arrangement of these two transverse walls on the firing channel and of these two orifices in the body of the security module thus enables an operator to easily remove the security module with the aid of simple ordinary screwdrivers without the need to provide an assembly clearance between the transverse flanges of the firing channel and the transverse sidewalls of this module.

The overall volume of the airbag device is thus reduced, together with its cost, due to the fact that no damping means are required.

The device can include the following preferred characteristics, taken alone or in combination:
the external faces of the transverse sidewalls of the body are set apart a distance corresponding to a distance separating the internal faces of the transverse flanges of the firing channel;
the firing channel is molded in one piece from an elastomer-filled thermoplastic resin;
the firing channel comprises two side guide flanges extending parallel to one another from and beneath the top wall and which partially surround the body of the security module;
the firing channel also comprises, close to its two side ends, two bearing box-structures extending from and beneath the top wall, the bottom end of each of the box-structures resting against one of the corresponding extensions of the body of the security module;
each of the box-structures abuts against the external face of one of the respective side guide flanges of the firing channel;
each of the transverse walls forms a part of one of the respective bearing box-structures;
each of the extensions of the body has a second orifice aligned with a respective hole formed in one of the corresponding box-structures, the device also comprising two screw/nut pairs each screwed through one of the second orifice and one of the holes; and/or
the top wall of the firing channel comprises two contiguous sections, the contours of which are delimited by less resistant frangible grooves capable of breaking under the pressure of the airbag in the event of the device being triggered so as to enable the opening of these sections and the deployment of this airbag in the passenger compartment.

According to a second aspect, a dashboard of a motor vehicle comprises a dashboard body and an airbag device as described above which is fixed onto the dashboard body.

### BRIEF DESCRIPTION OF THE DRAWINGS

The disclosure of the invention will now be followed by a detailed description of the invention, given here by way of non-limiting examples with reference to the accompanying drawings, in which:

FIG. 1 is an exploded perspective view of an airbag device;

FIG. 2 represents a cross-sectional view of the device in its assembled configuration, viewed along the plane passing through one of the openings of the body of the security module designed to be passed through by a rod; and

FIGS. 3 to 7 are views respectively similar to FIG. 2 but showing in chronological order the different steps of removal of the security module.

### DETAILED DESCRIPTION OF A PREFERRED EMBODIMENT

In the following description and by convention, the terms “front,” “back,” “above,” “below,” “longitudinal” and “transverse” will be defined in relation to the assembly position of the airbag device in a motor vehicle.

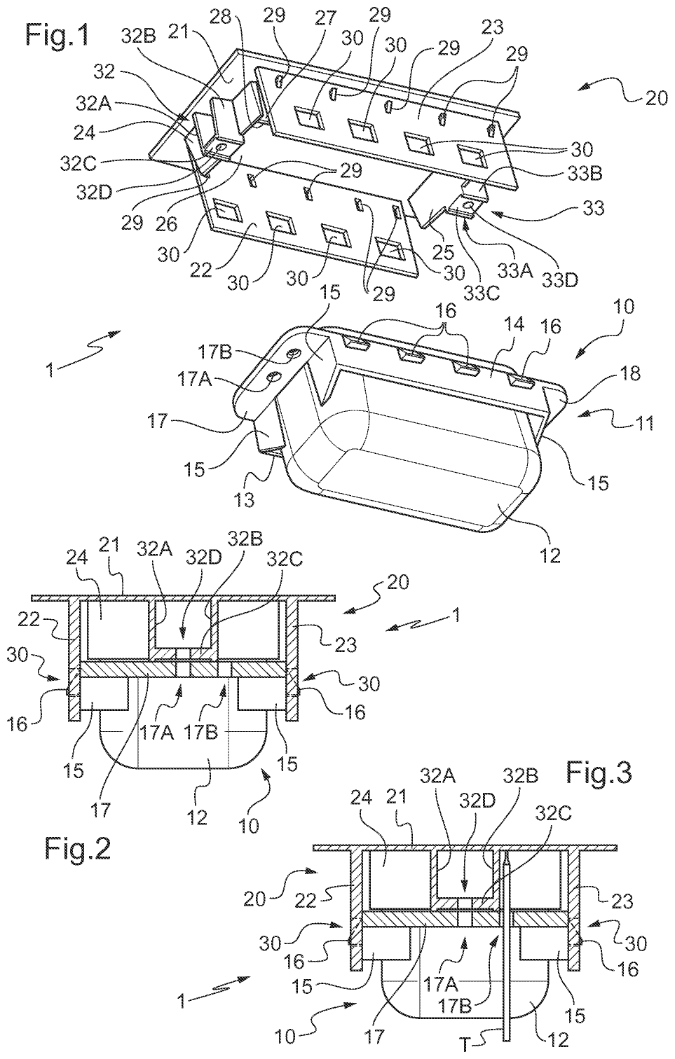

With reference to FIG. 1, the airbag device 1 comprises a security module 10 comprising a rigid body 11 forming a substantially parallelepiped casing 12 open at the top and housing a folded airbag as well as a gas generator (not shown in the Figures) to inflate this bag.

The device 1 also comprises a firing channel 20 conventionally comprising a top wall 21, the peripheral edge of which is designed to rest fixedly against the periphery of an opening provided in the body of the vehicle's dashboard.

The airbag device 1 is capable of adopting an assembled configuration, shown in FIG. 2, wherein the body 11 of the airbag module 10 is fixed onto the firing channel 20.

The firing channel, made of a material with certain elasticity, is advantageously molded in one piece from an elastomer-filled thermoplastic resin.

The firing channel also comprises front and back parallel transverse flanges, 22 and 23, respectively, as well as two parallel side flanges 24, 25 extending from and beneath the top wall 21.

The top wall 21 comprises two contiguous sections 26, 27, the contours of which are delimited by less resistant frangible grooves 28 capable of breaking under the pressure of the airbag in the event of the device 1 being triggered so as to enable the opening of these sections and the deployment of this airbag in the passenger compartment.

In order to fix the device to the body of the vehicle's dashboard, the transverse guide flanges 22, 23 of this firing channel 20 comprise, close to the top wall 21, a plurality of elastic snap-fit lugs 29 capable of cooperating with the periphery of the opening provided in the body of the dashboard.

These transverse guide flanges 22, 23 also have in their bottom part a plurality of rectangular windows 30 spaced at regular intervals along their length.

The firing channel 20 also comprises, close to its two side ends, two inverted U-shaped bearing box-structures 32, 33 extending from and beneath the top wall 21 and being centered therein along the median transverse plane of the firing channel 20.

The bearing box-structures 32, 33 abut the external face of their respective side flanges 24, 25. Each bearing box-structure 32, 33 comprises a front transverse wall 32A, 33A, a back transverse wall 32B, 33B, and a bottom wall 32C, 33C connecting the lower ends of these two transverse walls 32A, 32B, 33A, 33B. A circular hole 32D, 33D is formed in the central part of the bottom walls 32C, 33C.

Advantageously molded from a single piece of thermoplastic material, the rigid body 11 of the airbag module 10 also comprises front and rear parallel transverse sidewalls, 13 and 14, respectively, which are rigidly connected to the casing 12 by a plurality of ribs 15.

Forming respectively the front and rear ends of the body 11, these transverse sidewalls 13, 14 have on their outer faces a plurality of snap-fit teeth 16 formed by an inclined ramp extending to a projection, each capable of cooperating by clicking into a corresponding window 30 of the firing channel 20 when fitting the airbag module 10 onto the firing channel 20.

In the assembled configuration of the device 1, the transverse flanges 22, 23 and the side flanges 24, 25 of the firing channel 20 partially surround the body 11 of the security module 10, the snap-fit teeth 16 of the body 11 being engaged in the windows 30 of the firing channel with their projections facing the bottom edges of these windows 30 so as to prevent any unintentional or accidental removal of the security module 10 from the firing channel 20 (FIG. 2).

The external faces of the transverse sidewalls 13, 14 of the body are also spaced apart a distance corresponding to the distance separating the inner faces of the transverse flanges 22, 23 of the firing channel 20, so that in the assembled configuration of the device 1, these transverse front 13 and rear 14 sidewalls of the body 11 are abutting against the respective front 22 and rear 23 transverse guide flanges of the firing channel 20 (this absence of longitudinal clearance between the body 11 and the firing channel 20 enabling optimum compactness of the device 1).

The rigid body 11 of the airbag module 10 also comprises two extensions 17, 18, each projecting on either side from the top end of the casing 12.

In the assembled configuration of the device 1, these extensions 17, 18 extend parallel to the top wall 21 of the firing channel 20 and rest against the bottom ends (i.e., the bottom walls 32C, 33C) of the bearing box-structures 32, 33 (FIG. 2).

Each extension 17, 18 has a central circular orifice 17A (the one provided in the wall 18 not being visible in the Figures) located in the median transverse plane of the body 11 and positioned so as to be aligned with a corresponding hole 32D, 33D in the firing channel 20 when the device 1 is in its assembled configuration (see FIG. 2) so as to enable the possible screwing in, through these two orifice/drilled hole pairs, of two screw/nut pairs not shown and designed to eliminate any vertical clearance between the security module 10 and the firing channel 20.

Each extension 17, 18 also has, behind the orifice 17A, another orifice 17B (the latter provided in the wall 18 not being visible in the Figures) positioned so as to be located close to a respective rear transverse wall 32B, 33B of a corresponding bearing box-structure 32, 33 of the firing channel 20 when the device 1 is in its assembled configuration (see FIG. 2).

FIGS. 3 to 7 show the sequence of operations for removing an airbag module 10 in order to replace it.

The first step, not shown, may involve removing the two screws screwed through the orifices 17A, 32D and 33D (the nuts remaining attached to the bottom faces 32C and 33C of the bearing box-structures 32 and 33).

The operator must then vertically insert two rigid metal rods T (such as, for example, those of two ordinary screwdrivers) through the two central orifices 17B provided in the side walls 17, 18 of the body 11 of the airbag module 10 until the free ends of the rods T come into contact with the top wall 21 of the firing channel 20 (FIG. 3).

In this configuration, the top part of each of the two rods T is then located facing and almost in contact with the respective rear transverse wall 32B, 33B of a corresponding bearing box-structure 32, 33.

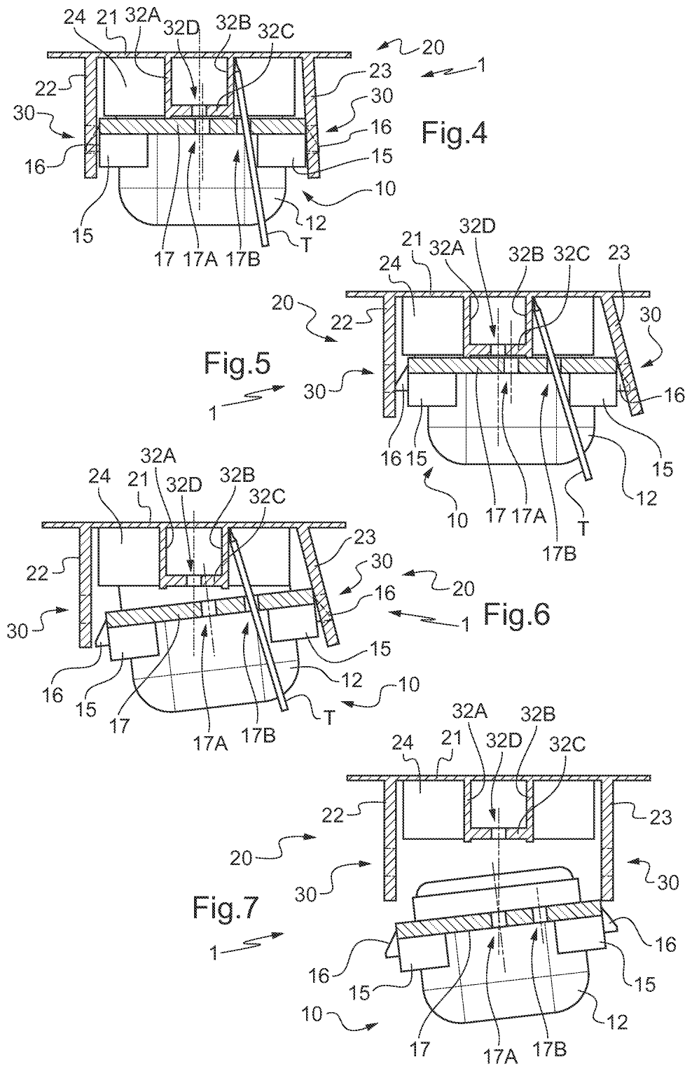

The operator must then simultaneously perform a lever movement of the two rods T making them pivot backwards about a transverse axis located at their free ends resting against the base of these rear transverse walls 32B, 33B (FIG. 4).

This pivoting of the rods T results in the backward translational movement of the security module 10 and the elastic deformation of the rear transverse guide flange 23 of the firing channel 20 which pivots backwards about its top end (this elastic deformation being made possible by the relative elasticity of this firing channel).

As a result of this backward translation of the security module 10, the snap-fit teeth 16 located on the front transverse sidewall 13 of the body 11 gradually begin to exit the corresponding windows 30 provided in the front transverse guide flange 22 of the firing channel 20.

The continuation of the backward pivoting movement of the rods T by the operator leads to the complete exit of these snap-fit teeth 16 from the corresponding windows 30 and thus their disengagement from the windows 30 of the transverse flanges of the firing channel (FIG. 5).

As the front part of the security module 10 is thenceforth no longer retained by the front transverse guide flanges 22 of the firing channel 20, this module 10 begins by gravity to tilt downwards about a transverse axis passing through the bearing areas of the projections of the snap-fit teeth 16 of the rear transverse sidewall 14 of the body 11 on the bottom edges of the corresponding windows 30 provided in the rear transverse guide flange 23 of the firing channel 20 which gradually returns to its initial position (FIG. 6).

The operator can then completely withdraw the two rods T and effortlessly remove the airbag module 10, which causes the return of the rear transverse guide flange 23 of the firing channel 20 to its initial position (FIG. 7).

According to variations not shown, the orifices 17B are positioned so as to be close to the front side walls 32A, 33A of the bearing box-structures 32, 33 of the firing channel 20 when the device is in its assembled configuration.

According to other variations not shown, the bearing box-structures can be omitted, and instead, the firing channel can be provided with only two vertical walls, such as walls 32B and 33B, capable of cooperating with two rods introduced through orifices 17B provided in the side walls 17 and 18 of the body 11 of the security module 10. In such a case, these side walls 17, 18 also have no central orifice 17A designed to receive a screw.

According to yet other variations not shown, the airbag device according to the invention is mounted on another interior trim element of the vehicle such as, for example, a side door panel.

Generally speaking, it will be remembered that the present invention is not limited to the embodiments described and represented, but includes all of the variations available to a person skilled in the art.

1. An airbag device for an interior trim element of a motor vehicle, the airbag device comprising:
a security module comprising a rigid body forming a casing that houses an airbag and a gas generator, and
a firing channel comprising a top wall designed to be fixed against said interior trim element when the airbag device is positioned in the vehicle and two transverse guide flanges extending parallel to one another from and beneath said top wall, said transverse guide flanges partially surrounding said body, the body also comprising two parallel transverse sidewalls each having a plurality of snap-fit teeth adapted to be received in respective windows provided in said corresponding transverse flanges (22, 23) of said firing channel (20);
wherein said firing channel also comprises two transverse walls proximate side ends of said firing channel and extending from and beneath said top wall,
said body of the security module also comprising two extensions each of which defines an orifice positioned to be close to one of said respective transverse walls of the firing channel when the airbag device is assembled; the orifices enabling two rods (T) having to be inserted through these orifices up to said top wall (21) of the firing channel to bear on these transverse walls whereby, when the rods are pivoted about a transverse axis they exert a lever effect causing said security module to move in longitudinal translation in relation to said firing channel thereby disengaging the teeth situated on one of said transverse sidewalls from the corresponding windows of the firing channel.

2. The airbag device according to claim 1, wherein external faces of said transverse sidewalls of said body are spaced apart a distance corresponding to a distance separating internal faces of said transverse flanges of the firing channel.

3. The airbag device according to claim 1 wherein said firing channel is molded in one piece from an thermoplastic resin loaded with an elastomer.

4. The airbag device according to claim 1, wherein said firing channel (20) comprises two side guide flanges extending parallel to one another from and beneath said top wall and partially surrounding said body of the security module.

5. The airbag device according to claim 1, wherein said firing channel also comprises, close to side ends, two bearing box-structures extending from and beneath said top wall, the bottom end of each of said box-structures resting against one of said corresponding extensions of said body of the security module.

6. The airbag device according to claim 5, wherein each of said box-structures abuts against an external face of one of said respective side guide flanges of the firing channel.

7. The airbag device according to claim 5, wherein each of said transverse walls forms a part of one of said respective bearing box-structures.

8. The airbag device according to claim 5, wherein each of said extensions of the body has a second orifice aligned with a respective hole in one of said corresponding box-structures, said device also comprising two screw/nut pairs each screwed through one of said second orifice and one of said holes of said box structures.

9. The airbag device according to claim 1, wherein said top wall of the firing channel comprises two contiguous sections, the contours of which are delimited by less resistant frangible grooves capable of breaking under the pressure of said airbag in the event of the device being triggered so as to enable the opening of these sections and the deployment of this airbag in the passenger compartment.

10. Dashboard A dashboard of a motor vehicle comprising a dashboard body and the airbag device according to claim 1, said airbag device being fixed onto said dashboard body.
